(19) United States
(12) Patent Application Publication
(10) Pub. No.: US 2026/0220525 A1
(43) Pub. Date: Jul. 30, 2026

(54) MACHINE LEARNING FOR DETERMINING MODEL SHARD COUNT

(71) Applicant: INTERNATIONAL BUSINESS MACHINES CORPORATION, ARMONK, NY (US)

(72) Inventors: Lin Dong, Beijing (CN); Qing Li, BEIJING (CN); Ze Ming Zhao, Beijing (CN)

(21) Appl. No.: 19/038,771

(22) Filed: Jan. 28, 2025

(51) Int. Cl. G06N 20/00

(52) U.S. Cl. CPC G06N 20/00

(57) ABSTRACT

A method for processing data in a parallel computing environment comprises: classifying layers of a machine learning model according to layer types; determining a model structure of the machine learning model; setting a shard number parameter as a hyperparameter for each layer of the layers; executing a hyperparameter tuning operation to select a shard number for the shard number parameter according to different model layers and model structures; and applying a loss function to the hyperparameter tuning operation to calculate a final shard number for the shard number parameter.

### BACKGROUND

Embodiments of the present invention relate generally to machine learning and to spreading machine learning models across multiple processors.

### SUMMARY

Embodiments of the present invention provide a method, a computer program product, and a computer system for processing data in a parallel computing environment, comprising: classifying layers of a machine learning model according to layer types; determining a model structure of the machine learning model; setting a shard number parameter as a hyperparameter for each layer of the layers; executing a hyperparameter tuning operation to select a shard number for the shard number parameter according to different model layers and model structures; and applying a loss function to the hyperparameter tuning operation to calculate a final shard number for the shard number parameter.

### BRIEF DESCRIPTION OF THE DRAWINGS

FIG. 1 is a block diagram of a system for model sharding, in which embodiments of the present inventive concept can be practiced.

FIG. 2 is a block diagram of a GPU shard number selection system, in accordance with some embodiments.

FIG. 3 is a flow diagram of a process for constructing and arranging graphic processing unit (GPU) shards in a parallel computing environment, in accordance with some embodiments.

FIG. 4 is a flow diagram of an example process for calculating a loss function, in accordance with some embodiments.

FIG. 5 is a block diagram of a computing environment, in accordance with embodiments of the present invention.

### DETAILED DESCRIPTION

A large language model (LLM) is a well-known type of deep learning model pre-trained on vast amounts of data and widely used in artificial intelligence (AI) to understand and generate human-like written responses to queries made via a computer. For example, an LLM can receive a source of text and image data as an input and generate an output based on the parameters of the model, referred to as language patterns, and the information they have learned over time. Deep learning models such as LLMs comprise billions of adjustable variables, or parameters provided for training the model, whereby the model is trained on many terabytes of text required for understanding and generating human language. Neural networks are used to build a model according to training data, and in doing so use many different layers consisting of neurons. Each layer in a deep learning model has a unique role in processing this enormous amount of data for the model.

The parameters of a model are the values that the learning algorithm can change independently as it learns. These parameters are what make up the model at the end of the learning process. For LLM, a greater number of parameters, for example, a billion or more, allow the model to generate more sophisticated responses to queries. However, this large number of parameters cannot be loaded into a single graphic processing unit (GPU) due to limited memory resources or result in slow or inefficient training on the single GPU if the parameters can be loaded.

To address this, multi-GPU configurations are available that rely on data parallelization techniques, where data, parameters, and overhead information are loaded into the different GPUs according to a sharding technique for storing this information on multiple machines.

Some approaches for training an LLM include arranging the model parameters of the model layers into GPU shards, where each shard permits a different processor, e.g., a GPU, to process a portion of the model parameters, including updating the parameters so that the model parameters can be trained in a distributed manner. One such technique is Fully Sharded Data Parallelism (FSDP), which reduces replications by applying a process called full parameter sharding, which is built on a Zero Redundancy Optimizer (ZeRO) technique intended to optimize memory usage by distributing, or sharding, the model states across multiple computers or processors such as GPUs, which process the received data in parallel, whereby the results are aggregated to produce the final output. FSDP addresses parallelization challenges in large model training. If a model has N layers, with Pₙ parameters in each layer, the total parameter set is the sum of all layer parameters. Additionally, during model training, there are intermediate results such as various gradients and optimizer states. Without parallelization, each GPU would need to store the complete parameter set, gradients, and optimizer states. However, with the emergence of large models, the parameter sets have become too large for a single GPU, making parallelization necessary.

While FSDP performs parallelism operations by sharding model parameters, only a subset of the model parameters, gradients, and optimizers needed for a local computation is made available. It's important to consider the trade-offs between shard count, GPU memory usage, communication overhead, and training performance. Increasing the shard count may reduce memory usage per shard but can also increase communication overhead. For example, data exchanges between different layers that are distributed to different GPUs can introduce communication overhead. Finding the right balance depends on the specific model, hardware configuration, and training requirements.

In brief overview, embodiments of the present inventive concept include a computer system and method for dividing model layers including their parameters into shards or other discrete subsets or units for parallel processing, regardless of model size or number of parameters. Conventional FSDP techniques have two disadvantages. In FSDP, per-GPU memory use may decrease since each GPU only maintains one shard, which contains a portion of parameters and corresponding gradients and optimizer states from the model layers. However, network communication overhead is increased due to all-gather and weight synchronization operations during training. Each sharded data set must understand how to route a querying operation to the appropriate shard, which introduces additional latency. Moreover, despite varying parameter sizes across layers, FSDP uses fixed shard numbers. For instance, with 5 shards, every layer is split into 5 parts regardless of its parameter count. This can lead to memory pressure for large parameter layers or unnecessary network overhead for small ones.

To overcome these limitations of conventional FSDP, embodiments of the present inventive concept classify each layer, or unit comprising a plurality of layers, by size, e.g., small, medium, or large, based on parameter count, or on the number of neurons, and/or by model structure, such as feedforward neural network (FNN), convolutional neural network (CNN), recurrent neural network (RNN), generative adversarial network (GAN), autoencoder, transformer, and so on. For each layer type, a hyperparameter is generated. For example, a hyperparameter can be added to the model files that identifies each layer as being small, medium, or large. In some embodiments, a hyperparameter tuning system is executed to select an optimum shard number based on the model's performance with respect to efficiency in processing shards, etc. The model is trained with this sharding configuration while monitoring memory use, network throughput, and latency. The hyperparameters are optimized through a loss evaluation. For example, a hyperparameter tuning system can execute a search algorithm to improve the accuracy of determining the optimum shard number for a given model layer. When considering the model structure, all types of hyperparameters and computational complexities regarding all model layers can be processed, including hidden layers. Conventional sharding approaches such as FSDP, on the other hand, only gather parameters of layers of a single instance, where only a subset of model parameters, gradients, and optimizers needed for a local computation is made available.

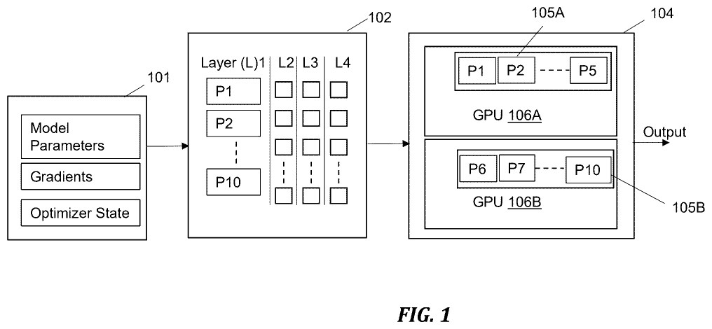

FIG. 1 is a block diagram of a system for sharding a model, in which embodiments of the present inventive concept can be practiced.

An LLM 102 shown in FIG. 1 can include billions or trillions of parameters and corresponding gradients and optimizer states. The intermediate results 101, or sharded objects, are processed by the LLM 102. LLM 102 is built according to the training data to predict unseen data using a plurality of layers (L1-L4) consisting of neurons. Although four layers (L1-L4) are shown, embodiments are not limited thereto and are likely to include more than four layers. Each layer used to construct the neural network plays a unique role in the process of converting input data into relevant outputs. The flow of information through the layers is sequential, with each layer taking input from the preceding layers and passing its transformed output to the subsequent layers. This cascading process continues through the network until the final layer produces the model's ultimate output. Accordingly, the layers L1-L4 may comprise a combination of input, hidden, and output layers, and/or other layer types known to be part of deep neural networks.

The LLM 102 can be divided at a distributed training system, which includes a plurality of machines 104 each machine 104 including a plurality of GPUs 106A, 106B (generally, 106) and/or other computer processors. Here, each GPU shard 105A, 105B (generally 105) is assigned to a different GPU 106A, 106B. Each layer L1-L4 may correspond to a unit for processing by the GPUs 106. In some embodiments, for each unit, the layer parameters P1-P10 can be divided equally for each GPU 106. For example, as shown in FIG. 1, layer L1 has parameters P1-P5 arranged as shard 105A which is loaded into and processed by GPU 106A and has parameters P6-P10 of layer L1, arranged as shard 105B, which is loaded into and processed by GPU 106B. In another example (not shown), a layer may have parameters equally divided between three different GPUs. In other embodiments, multiple layers, for example layers L1 and L2, can be under a single unit, and equally divided into multiple shards, for example, combinations of parameters of a group of multiple layers L1 and L2 may be processed by one GPU 106A, and another combination of parameters of layers L1 and L2 may be processed by another GPU 106B. In other embodiments, multiple layers can be divided into multiple GPUs, for example, the parameters of Layers L1-L4 equally divided as shards 105 into the GPUs 106. It is not required that all GPUs 106 in a configuration receive layer parameters, and instead only a subset of GPUs may be required depending on the loss function optimization requirements. In some embodiments, during training after the input data 101 is processed through the layers L1-L4 of the shards 105, the results are stored in GPU memory if the GPU memory is available or transferred to a different memory such as CPU RAM if the GPU memory is limited. During processing each shard is processed separately and in parallel with different GPUs and the results are synchronized or aggregated at the output.

As described above, it is important to consider the trade-offs between shard count, GPU memory usage, communication overhead, and training performance. It is therefore desirable to consider GPU memory usage, communication overhead, and training performance in determining an optimal number of shards for a predetermined GPU configuration. For example, communication overhead is different for each model structure: FNN, CNN, RNN, GAN, autoencoder, transformer, and so on. Increasing the shard count may reduce memory use per shard but increase communication overhead, which may be undesirable for some model structures. The model sharding system of FIG. 1 can incorporate a GPU shard number selection system that depends on the specific model, hardware configuration, and training requirements when generating a number of shards for a predetermined GPU configuration.

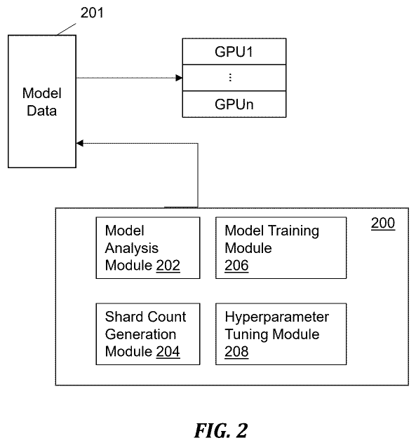

FIG. 2 is a block diagram of a GPU shard number selection system 200, in accordance with some embodiments. For example, the GPU shard number selection system 200 can determine a shard count, or the number of shards 105 of FIG. 1 for each GPU or other computer processor in a multi-processor computing environment based on the model type, layer arrangement, and/or number of available GPUs of FIG. 1.

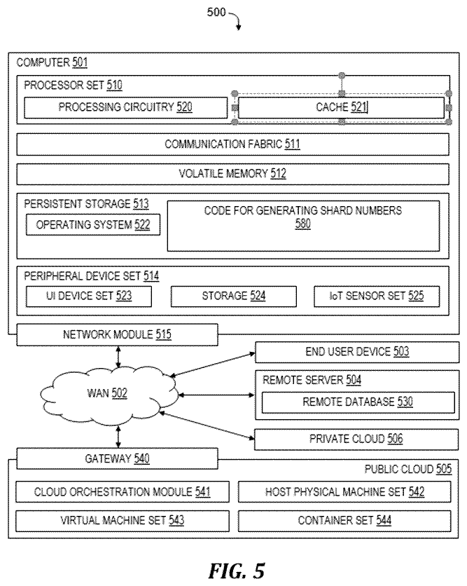

The GPU shard number selection system 200 controls a shard assignment system 201 that assigns units to specific layers for sharding, namely, sharding each unit across the GPUs. In some embodiments, the GPU shard number selection system 200 comprises a model analysis module 202, a shard generation module 204, a model training module 206, and a hyperparameter tuning module 208. Some or all of the modules of the GPU shard number selection system 200 can be stored and/or executed on one or more computer systems, for example, on one or more of the computer systems shown and described in FIG. 5.

The model analysis module 202 is constructed and arranged to classify the layer type of the layers of the LLM 102, for example, categorizing layers as small, medium, or large based on parameter count. Each layer size, e.g., small, medium, and large, can be predefined, for example, defined as having a particular number of neurons, parameters, e.g., a number of neurons that are within a specified numerical range, and so on. In some embodiments, the analysis results produced by the model analysis module 202 are arranged by the shard count generation module 204 into units, or shards. As is well known, each shard contains a portion of parameters from predetermined model layers, along with corresponding gradients and optimizer states.

The shard count generation module 204 can determine shard numbers using hyperparameters, for example, establishing a shard number as small, medium, or large. For example, in a model with 10 layers, layers 1-3 may be arranged in a first unit, layers 4-6 may be arranged in a second unit, and layers 7-10 may be arranged in a third unit. As described herein, each shard is processed by a unique GPU. In some embodiments, the size and number of units are determined based on factors such as number of GPUs, processing capabilities, layer number, size, and type, number of received parameters, and so on.

For example, the model analysis module 202 and shard count generation module 204 can establish that a unit should be divided among all GPUs in a configuration, or divided among a subset, i.e., some but not all GPUs in the configuration. In other embodiments, the model analysis module 202 categorizes the model structure. For example, the model structure can be determined to be a FNN, CNN, RNN, GAN, autoencoder, and/or transformer, etc. For a given model, the layers may have varying sizes. A layer size may be determined by the number of parameters, gradients, and/or other data in the model files. The layers categorized by size can be used to establish the manner in which the layers are sharded and processed by the GPUs in a data parallelism operation, for example, as shown in FIG. 1. Here, a plurality of data processing devices, e.g., GPUs are configured to execute the deep neural network model, e.g., LLM in parallel, but in an efficient manner since each independent GPU may process layers or units having a size and type predetermined by a hyperparameter tailored specifically for determining an optimum shard number.

The model training module 206 trains the model using the sharding configuration provided by the model analysis module 202, which categorizes the layers, and by using the shard numbers determined by the shard count generation module 204. The shard count generation module 204 determines the shard numbers using hyperparameters. The model training module 206 also monitors memory usage, network throughput, and latency to collect information for processing by the hyperparameter tuning module 208.

The hyperparameters used by the shard count generation module 204 are generally added to the model files to determine the shard number for each type of layer according to both the model layer and model structure. The hyperparameter tuning module 208 optimizes these hyperparameters through a loss function evaluation. In doing so, the hyperparameter tuning module 208 employs an algorithm to measure the performance of the machine learning model for the shard number calculations and in doing so optimizes the hyperparameters to select the best shard number according to model layer and structure. This operation may collect performance data from the model training module 206 regarding GPU memory usage and shard and neural network efficiency to determine the performance of the LLM. The loss function can be used to determine an optimum shard number for each layer of a model in the next cycle and update the hyperparameters to reduce loss, which feeds back to machine learning model.

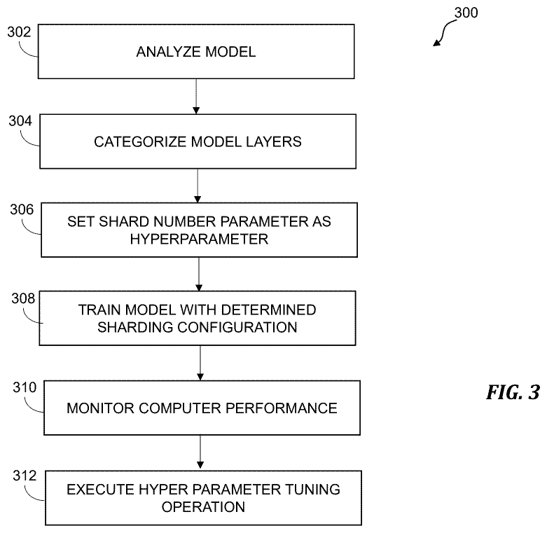

FIG. 3 is a flow diagram of a process 300 for constructing and arranging graphic processing unit (GPU) shards in a parallel computing environment, in accordance with some embodiments. In describing the process 300, reference is made to the system of FIGS. 1 and 2.

At step 302, an artificial intelligence model is analyzed by the model analysis module 202. The model comprises a plurality of layers, each comprising a plurality of neurons. For example, the model is or includes an LLM comprising an input layer which receives the data, one or more hidden layers, and an output layer. In some embodiments, the model analysis module 202 classifies each layer type and model structure.

At step 304, the model layers are categorized by parameter count, for example, are categorized as small, medium, or large based on the analysis results, namely, the layer type and model structure. The size categorization may be determined by the number of neurons or parameters of each layer. The size categorization may also be determined by the type of layer. For example, a layer of an FNN is different than a layer of a CNN, even if each layer comprises the same number of neurons.

At step 306, for each layer, a parameter is set that identifies the layer size as a model hyperparameter. For example, a determined “small layer” in step 304 may have a parameter “shard_number_small” set as a hyperparameter.

At step 308, the model is trained with the sharding configuration determined in steps 302-306.

At step 310, the computing environment in which the model operates is monitored for memory usage, network throughput, latency, and/or other performance-related metrics.

At step 312, the hyperparameters used for determining the shard numbers are optimized by a loss function evaluation, where a hyperparameter tuning operation including a loss function is executed. In some embodiments, the loss function processes the performance metrics monitored and collected at step 310 for determining an optimum shard number result for each layer of the model. In at least some embodiments, choosing different hyperparameters to try in the process 300 is implemented via a hyperparameter search algorithm such as one or more of a grid search, a random search, a Bayesian optimization, etc.

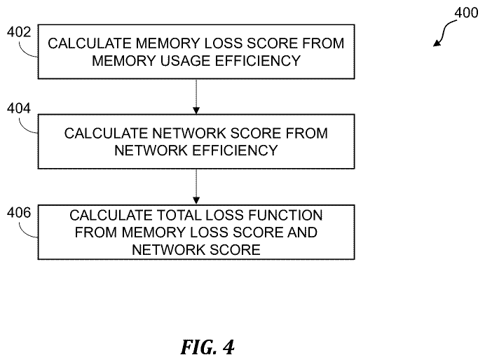

FIG. 4 is a flow diagram of an example process 400 for calculating a loss function, in accordance with some embodiments. The process 400 can be used for training a large neural network model such as an LLM but is not limited thereto. At step 312, the loss function is important in determining an optimum shard value of each layer of a model to maintain values of each layer so that the parameters of the model are optimally partitioned and so that the resulting shards are provided to, and processed by, a respective independent computing unit, e.g., GPU.

When calculating the total loss function, each layer combines two components: memory usage efficiency and network efficiency as shown in equation (1):

$$efficiency ( shards ) = {\sum }_{layer 1}^{layern} {efficiency}_{memory} ( m ) + {efficiency}_{network} ( t , l ) \qquad ( 1 )$$

Here, memory usage efficiency (efficiency_{memory}) is the loss of memory, and at step 402, a memory loss score value between 0-100 is calculated. The m variable represents an observed value of memory usage, the t variable represents the observed value of network throughput, and the l variable represents the observed value of network latency. Generally, the highest scores are given in response to the GPU(s) of interest operating its/their memory near the memory threshold of the GPU(s) of interest. Memory loss scores below the highest scores generally drop sharply, as shown in the output data shown in Table 1. In some embodiments, the memory threshold is determined based on the memory size of a single GPU card, or other computing device where the shards determined from the process 300 are to be processed.

The network efficiency (efficiency_{network}) is the loss of network, and at step 404, a network loss score value between 0-100 is calculated. Network loss score values are generated based on throughput and latency values, with a higher score being generated for greater throughput and lower latency. Normalization is performed to accommodate different scales. At step 406, a total loss function is determined from a sum of the outputs of steps 402 and 404.

With further regard to the memory loss score function of step 402, equation (2) recites:

$$score = 100 * quadratic\_part * sigmoid\_part , where : quadratic\_part {( value - threshold )}^{2} and sigmoid\_part = 1 / ( 1 + {e}^{∧} ( k * ( value - threshold ) ) ) . \qquad ( 2 )$$

The formula for determining the memory efficiency can apply the score from equation (2) as shown in equation (3):

$${efficiency}_{memory} ( m ) = {( m - memory\_threshold )}^{2} * \frac{100}{1 + {e}^{k * ( m - memory \_ threshold )}} \qquad ( 3 )$$

With further regard to equation (2), when quadratic_part is equal to value-threshold, this normalizes memory usage to a [0,1] interval. The exponential square term accelerates growth as it approaches the threshold. A calculation at step 402 may slow growth at low usage, which reflects a relaxed policy when memory is sufficient. The variable sigmoid_part is calculated by: value—threshold, which is the calculated distance from threshold k, which is a parameter controlling function's steepness. The formula: e\hat{ }(steepness*(value−threshold)) may produce values indicating a rapid increase beyond the threshold. The formula 1/(1+x) structure ensures output in a [0,1] interval has a smooth transition at the threshold to avoid discontinuity.

The score recited in equation (2) is the same as the efficiency_{memory}(m) in equation 3. The value recited in equation (2) is the same as the m variable in equation (3), and threshold recited in equation (2) is the same as memory_threshold in equation (3). A property of the result from equation (3) having an output range: [0,100] before the threshold includes increases with memory usage having a corresponding acceleration growth. In addition, addressing the loss function after the threshold allows for a smooth decline instead of an abrupt drop. The generated results allow for the properties of the memory efficiency to be continuous and differentiable.

With further regard to the network loss score value function of step 404, equation (4) recites:

$$score = 100 * ( α * normalized\_throughput + ( 1 - α ) * normalized\_latency ) where : normalized\_throughput = log ( throughput + 1 ) / log ( max\_throughput + 1 ) normalized\_latency = ( log ( max\_latency ) - log ( latency ) ) / ( log ( max\_latency ) - log ( min\_latency ) ) \qquad ( 4 )$$

The formula for determining the memory efficiency can apply the score from equation (4) as shown in equation (5):

$${efficiency}_{network} ( t , l ) = 100 * ( \frac{α log ( t + 1 )}{log ( thru\_max + 1 )} + \frac{( 1 - α ) log ( latentcy\_max - l )}{log ( latency\_max - latency\_min )} ) \qquad ( 5 )$$

Referring again to equation (4), normalized_throughput: throughput+1 prevents a log(0) case. The log function can have a wide range of throughput values. A division operation by log(max_throughput+1) normalizes memory usage to a [0,1] interval. The logarithmic transformation reduces sensitivity to high throughput changes.

The normalized_latency factor of the score of equations (4) and (5) includes variables: log(latency), which handles order of magnitude differences, and log(max_latency)−log(latency), where a smaller latency yields larger result. Here, the denominator term normalizes to [0,1] interval. The logarithmic difference reduces sensitivity to extreme latencies.

The combined terms in equation (4) include the weight parameter (a), which may have a default value, for example, 0.6, where throughput is slightly more important than latency. The latency weight (1−α) is a weighted average that ensures balance between metrics.

The properties result from equation (5) where an output range [0,100] includes a higher score with higher throughput, a higher score with lower latency, an adjustable balance through a parameter, and a logarithmic transformation that handles scale differences.

Table 1 illustrates an example output of the two loss functions:

TABLE 1

Memory Threshold: 256 G, Memory usage: 0 G −> Score: 0.00
Memory Threshold: 256 G, Memory usage: 100 G −> Score: 15.26
Memory Threshold: 256 G, Memory usage: 150 G −> Score: 34.33
Memory Threshold: 256 G, Memory usage: 200 G −> Score: 61.04
Memory Threshold: 256 G, Memory usage: 230 G −> Score: 80.72
Memory Threshold: 256 G, Memory usage: 250 G −> Score: 90.84
Memory Threshold: 256 G, Memory usage: 260 G −> Score: 12.30
Memory Threshold: 256 G, Memory usage: 300 G −> Score: 0.00
Throughput: 1000 Mbps, Latency: 1 ms −> Score: 100.00
Throughput: 500 Mbps, Latency: 10 ms −> Score: 73.99
Throughput: 100 Mbps, Latency: 20 ms −> Score: 54.06
Throughput: 10 Mbps, Latency: 50 ms −> Score: 26.85
Throughput: 1 Mbps, Latency: 100 ms −> Score: 6.02

As shown in Table 1, with respect to the memory loss score loss function determined in step 402, the highest score (90.84) is generated at or near the threshold (256 GB) at a memory usage of 250 GB. However, the score decreases rapidly if the memory usage (260 GB) is greater than the threshold. In accordance with the total loss function according to equation (1), this is indicative of memory usage efficiency, where optimum efficiency occurs where higher scores for memory efficiency are present. With respect to the network loss score function, shown in Table 1, it is the highest score at the greatest throughput and the lowest latency.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 5 is a block diagram of a computing environment for observability data processing, in accordance with embodiments of the present invention.

Computing environment 500 contains an example of an environment for the execution of at least some of the computer code involved in performing the inventive methods, such as code 580 for determining shard numbers, for example, according to FIGS. 3 and 4. The aforementioned computer code is also referred to herein as computer-readable code, computer-readable program code, and machine readable code. In addition to block 580, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 580, as identified herein), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer-readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 580 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 580 typically includes at least some of the computer code involved in performing embodiments of the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer-readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

CLOUD COMPUTING SERVICES AND/OR MICROSERVICES (not separately shown in FIG. 5): private and public clouds 506 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
classifying layers of a machine learning model according to layer types;
determining a model structure of the machine learning model;
setting a shard number parameter as a hyperparameter for each layer of the layers;
executing a hyperparameter tuning operation to select a shard number for the shard number parameter according to different model layers and model structures; and
applying a loss function to the hyperparameter tuning operation to calculate a final shard number for the shard number parameter.

2. The method of claim 1, wherein the loss function is a total loss function comprising a memory loss score function and a network score function.

3. The method of claim 1, further comprising:
processing shards according to the final shard number by at least a subset of available GPUs in parallel.

4. The method of claim 1, wherein the classifying the layers is based on a number of neurons of each layer.

5. The method of claim 1, wherein the layer types include a small layer type, a medium layer type, and a large layer type.

6. The method of claim 1, wherein the model structure is one of a feedforward neural network (FNN), a convolutional neural network (CNN), a recurrent neural network (RNN), a generative adversarial network (GAN), an autoencoder, and a transformer.

7. The method of claim 1, wherein the final shard number is calculated according to an output of the loss function.

8. The method of claim 1, wherein the hyperparameter tuning operation is performed in test runs, wherein in each test run, hyperparameters are applied for each layer to determine if a test shard number satisfies a predetermined threshold, wherein in response to the loss function producing a value that is equal to or exceeds the threshold in response to a test run of the test runs, then the test shard number is generated as the final shard number.

9. The method of claim 1, wherein each of the layers is classified as a different layer type.

10. The method of claim 1, wherein the layers are arranged into units, a size of each unit is determined in response to the hyperparameter tuning operation and the loss function, and each unit is configured for receipt and processing by a graphical processing unit.

11. The method of claim 1, further comprising:
determining a number of GPUs for receiving the layers, wherein each layer is divided into different parts and occupies different numbers of GPUs based on the loss function being optimized.

12. A computer program product comprising:
one or more computer readable storage media; and
program instructions stored on the one or more computer readable storage media to perform operations comprising:
classifying layers of a machine learning model according to layer types;
determining a model structure of the machine learning model;
setting a shard number parameter as a hyperparameter for each layer of the layers;
executing a hyperparameter tuning operation to select a shard number for the shard number parameter according to different model layers and model structures; and
applying a loss function to the hyperparameter tuning operation to calculate a final shard number for the shard number parameter.

13. The computer program product of claim 12, wherein the loss function is a total loss function comprising a memory loss score function and a network score function.

14. The computer program product of claim 12, wherein the layer types include a small layer type, a medium layer type, and a large layer type.

15. The computer program product of claim 12, wherein the layers are arranged into units, a size of each unit is determined in response to the hyperparameter tuning operation and the loss function, and each unit is configured for receipt and processing by a graphical processing unit.

16. The computer program product of claim 12, further comprising:
determining a number of GPUs for receiving the layers, wherein each layer is divided into different parts and occupies different numbers of GPUs based on the loss function being optimized.

17. A computer system comprising:
a processor set;
one or more computer-readable storage media; and
program instructions stored on the one or more computer-readable storage media to cause the processor set to perform operations comprising:
classifying layers of a machine learning model according to layer types;
determining a model structure of the machine learning model;
setting a shard number parameter as a hyperparameter for each layer of the layers;
executing a hyperparameter tuning operation to select a shard number for the shard number parameter according to different model layers and model structures; and
applying a loss function to the hyperparameter tuning operation to calculate a final shard number for the shard number parameter.

18. The computer system of claim 17, wherein the loss function is a total loss function comprising a memory loss score function and a network score function.

19. The computer system of claim 17, wherein the layer types include a small layer type, a medium layer type, and a large layer type.

20. The computer system of claim 17, wherein the layers are arranged into units, a size of each unit is determined in response to the hyperparameter tuning operation and the loss function, and each unit is configured for receipt and processing by a graphical processing unit.
